(19) United States
(12) Patent Application Publication
(10) Pub. No.: US 2011/0234985 A1
(43) Pub. Date: Sep. 29, 2011

(54) DESPECKLING LASER-IMAGE-PROJECTION SYSTEM

(75) Inventors: Roland Ryf, Aberdeen, NJ (US); Gang Chen, Bridgewater, NJ (US)

(73) Assignee: ALCATEL-LUCENT USA INC., Murray Hill, NJ (US)

(21) Appl. No.: 12/732,504

(22) Filed: Mar. 26, 2010

(51) Int. Cl. G03B 21/14

(52) U.S. Cl. 353/38

(57) ABSTRACT

An optical device for projecting an image is disclosed. In one embodiment, the optical device includes a configurable optical diffuser adapted to produce a diffuse optical beam having a temporally varying pattern of angular divergence. The optical device further includes a plurality of lenslet pairs to shape the diffuse optical beam and a spatial light modulator to spatially modulate the shaped optical beam to project an image.

### BACKGROUND

1. Field of the Invention

The subject matter described herein relates generally to image projectors and hand-held electronic devices and, more specifically but not exclusively, to despeckling laser-image-projection systems.

2. Description of the Related Art

This section introduces aspects that may help facilitate a better understanding of the invention(s). Accordingly, the statements of this section are to be read in this light and are not to be understood as admissions about what is in the prior art or what is not in the prior art.

A projector is a device that integrates a light source, optics, electronics, and a light-modulating element for the purpose of projecting an image or a sequence of images, e.g., from a computer or video input, onto a wall or screen for large-image viewing. There are many projectors available in the market, and they are differentiated by their size, resolution, performance, and other features. Some projectors employ laser light sources because the use of lasers enables creation of vibrant images with extensive color coverage that can be difficult to achieve with other (non-laser) light sources.

A compact image projector, e.g., one that can be incorporated into a cell phone and used to project a relatively large image on a wall or an 8.5″×11″ sheet of paper, is of great interest to electronic-equipment manufacturers. While the compactness of modern hand-held electronic devices is advantageous for portability purposes, their relatively small size, by its very nature, creates a disadvantage with respect to the display of visual information. More specifically, the display screen of a cell phone, personal digital assistant (PDA), or portable media player is typically too small to present most documents in their original full-page format, or graphics and video content at their original resolution. Having a compact image projector instead of or in addition to a regular display screen in a hand-held electronic device would help to solve these problems because it would enable the user to display and view the visual information in its most-appropriate form.

### SUMMARY

One significant obstacle to laser-image projection is the speckle phenomenon that tends to superimpose a granular structure on the perceived image. Since speckle can both degrade the image sharpness and annoy the viewer, speckle mitigation is highly desirable. However, the small size of a compact image projector makes it relatively difficult to incorporate an adequate despeckling functionality therein.

Disclosed herein are various embodiments of a laser-image-projection system having (i) a fly's eye (FE) integrator including a plurality of lenslet pairs and (ii) a configurable optical diffuser, both located along an optical path between a laser and a spatial light modulator (SLM). In various embodiments, the optical diffuser introduces a temporally varying pattern of angular divergence into a laser beam directed toward the FE integrator for transmission to the SLM. In various embodiments, the FE integrator produces a plurality of illumination patches that are superimposed on the SLM in a manner that is substantially independent of the temporal variations introduced by the optical diffuser. Consequently, the regions of illumination produced by different pairs of opposing lenslets can overlap despite the presence of temporal variations in the angular divergence produced by the optical diffuser. Advantageously, the optical diffuser and FE integrator work together in a synergistic manner to enable the laser-image-projection system to be relatively compact and to provide relatively high illumination homogeneity across the SLM, relatively high temporal/spatial stability of the illumination patch, relatively high optical throughput between the laser and the projection screen, and relatively low speckle noise in the projected image.

According to one embodiment, an optical device for projecting an image has a configurable optical diffuser adapted to produce a diffuse optical beam having a temporally varying pattern of angular divergence. The optical device also has a fly's eye (FE) integrator adapted to shape the diffuse optical beam. The optical device further has a spatial light modulator (SLM) adapted to spatially modulate the shaped optical beam produced by the FE integrator to project the image.

According to another embodiment, an optical device for projecting an image has a pair of crossed cylindrical lenses to provide collimated coherent light. The optical device also has a moveable diffuser to receive the collimated coherent light to produce a diffuse optical beam having a temporally varying pattern of angular divergence. The optical device further has a plurality of lenslet pairs arranged side by side with each other and adapted to shape the diffuse optical beam.

### BRIEF DESCRIPTION OF THE DRAWINGS

Other aspects, features, and benefits of various embodiments of the invention will become more fully apparent, by way of example, from the following detailed description and the accompanying drawings, in which:

FIG. 1 shows a top view of a projector according to one embodiment of the invention;

FIGS. 2A-D schematically show the operation of an optical beam-shaping section in the projector of FIG. 1;

FIG. 3 shows a lenslet array that can be used in a fly's eye (FE) integrator of the projector shown in FIG. 1 according to one embodiment of the invention; and

FIG. 4 shows a three-dimensional perspective view of a hand-held electronic device according to one embodiment of the invention.

### DETAILED DESCRIPTION

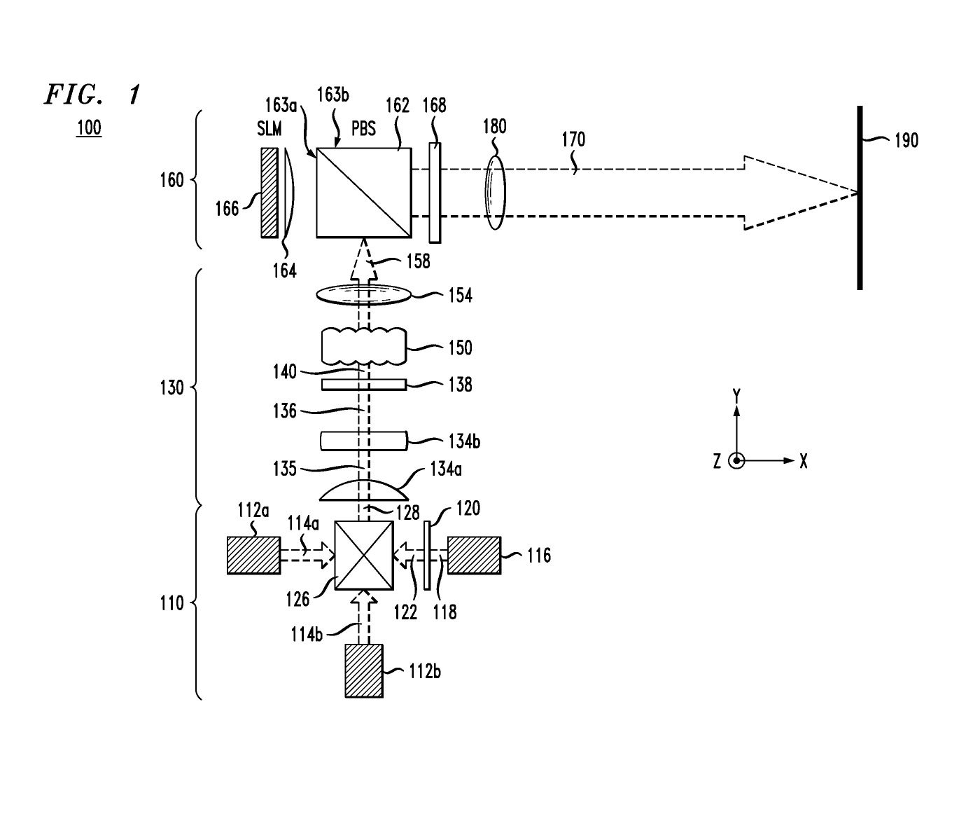

FIG. 1 shows a top view of a projector 100 according to one embodiment of the invention. Projector 100 has a laser light source 110 adapted to feed multi-colored light (e.g., red, green, and blue) through an optical beam-shaping (OBS) section 130 into a modulator section 160. Modulator section 160 generates a spatially intensity-modulated beam 170 that, after passing through a projection lens 180, forms a color image on a screen 190, which is not part of projector 100. In one embodiment, projection lens 180 is a compound lens comprising two or more individual lens pieces (not explicitly shown in FIG. 1). Although the term “screen” is used, it should be understood to include any suitable surface capable of supporting an image. For example, a screen can be an absorptive or reflective passive surface or active surface, such as a semiconductor surface, to enable further image processing.

Light source 110 has a set of three lasers 112a, 112b, and 116, each adapted to generate pulsed light of a designated color, e.g., red, green, and blue, respectively. Lasers 112a-b and 116 can be synchronized so that modulator section 160 receives a periodic train of pulses. For example, each illumination period may have three or more sequential pulses of different colors, wherein the pulses appear at a selected repetition rate. Commonly owned U.S. Pat. No. 7,502,160 and U.S. Patent Application Publication No. 2009/0185140 describe various methods of time multiplexing light pulses of various colors suitable for use in light source 110. Said U.S. Patent and U.S. Patent Application Publication are incorporated herein by reference in their entirety.

Optical beams 114a-b generated by lasers 112a-b are diverging or collimated light beams, each having a generally oval cross-section. The generally oval cross-section is produced because laser 112 emits light having different angular spreads along different axes orthogonal to the emission axis of the laser. For example, laser 112a emits light having different angular spreads along the Y and Z coordinate axes. Similarly, laser 112b emits light having different angular spreads along the X and Z coordinate axes.

Optical beam 118 generated by laser 116 is a diverging or collimated light beam having a generally circular cross-section. This generally circular cross-section is produced because laser 116 emits light having substantially the same angular spreads along different (e.g., Y and Z) axes orthogonal to the emission axis of the laser. An elliptical diffuser 120 located in front of laser 116 transforms optical beam 118 into a diverging light beam 122 having a generally oval cross-section, thereby making light beam 122 qualitatively similar to light beams 114a-b.

A color combiner (also often referred to as an X-cube) 126 (re)directs the light beams received from lasers 112a, 112b, and 116 toward OBS section 130. In one embodiment, emission characteristics of lasers 112a, 112b, and 116, beam-shaping characteristics of elliptical diffuser 120, and relative positions of different optical elements in light source 110 are selected so that, at the output of color combiner 126, the three light beams generated by the lasers overlap spatially and directionally to form a combined diverging light beam 128. In various embodiments, formation of a combined diverging light beam 128 includes maximizing the spatial overlap of two or more of light beams 114a, 114b, and 122. In various embodiments, formation of combined diverging light beam 128 includes optimizing the directionality of one or more of light beams 114a, 114b, and 122.

Although light source 110 is shown in the embodiment of FIG. 1 as having two lasers 112 and one laser 116, other laser-type combinations are also possible. For example, in an alternative embodiment, light source 110 can have one laser 112 and two lasers 116, wherein each of lasers 116 is equipped with a corresponding elliptical diffuser that is analogous to elliptical diffuser 120. In other alternative embodiments, all three lasers in light source 110 may be lasers of the same type, e.g., lasers 112 or lasers 116.

In one embodiment, each of lasers 112 in light source 110 is implemented as a semiconductor laser diode or a diode-pumped solid-state laser. As known in the art, a typical edge-emitting semiconductor laser diode emits a cone of light having a generally oval cross section. In a representative configuration, the semiconductor laser diodes (lasers 112a-b) are oriented so that the short axis of each respective oval is substantially parallel to the Z coordinate axis while the long axis of the oval is parallel to the XY plane. As a result, optical beam 128 has an anisotropic angular distribution, with the vertical angular spread of the beam being narrower than the horizontal angular spread.

In one configuration, each of lasers 112 and 116 generates S-polarized light, i.e., light whose electric field is substantially parallel to the Z coordinate axis. In addition, light source 110 can have an optional polarizer or other birefringent element (not explicitly shown) that serves to adjust, if necessary, the polarization of optical beam 128 to S polarization. One skilled in the art will understand that light source 110 can alternatively be configured to generate P-polarized light, provided that modulator section 160 is reconfigured accordingly so that a P-polarized input, instead of the S-polarized input, is appropriate for operation of modulator section 160. Such reconfiguration can include, e.g., relocating a spatial light modulator (SLM) 166 and a field lens 164 in modulator section 160 from the shown positions, which are next to a face 163a of a polarization beam splitter (PBS) 162, to similar positions next to a face 163b of the PBS.

In one embodiment, the following commercially available lasers can be used to implement lasers 112 and 116 in light source 110: (1) laser models HL6388MG and HL6385DG manufactured by Opnext, Inc. (Japan) for the generation of red light; (2) laser models NDHB510APA and NDB711E manufactured by Nichia Corporation (Japan) for the generation of blue light; and (3) laser models MiniGreen 200 and MiniGreen 150 manufactured by Snake Creek Lasers LLC (Pennsylvania) for the generation of green light.

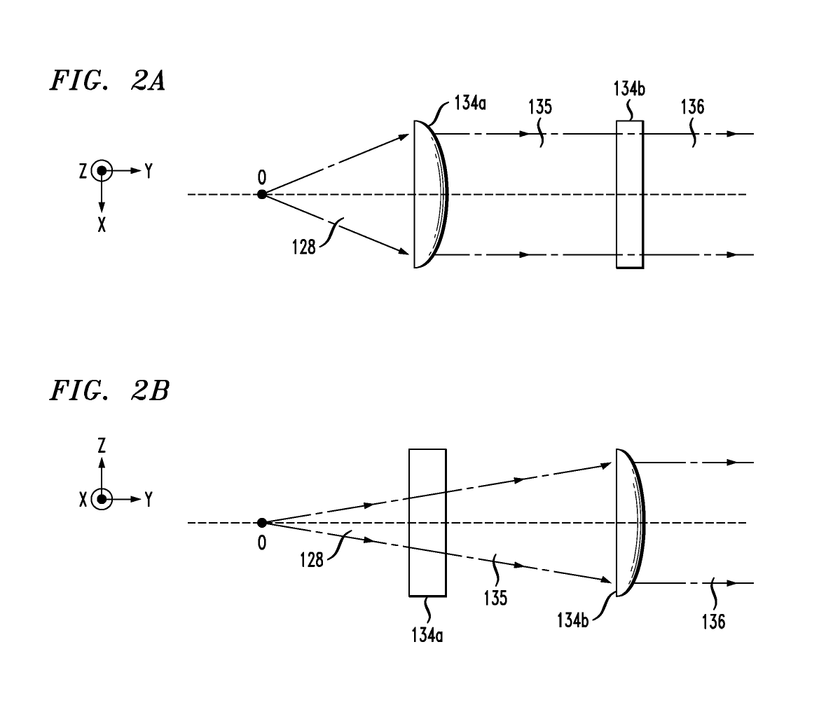

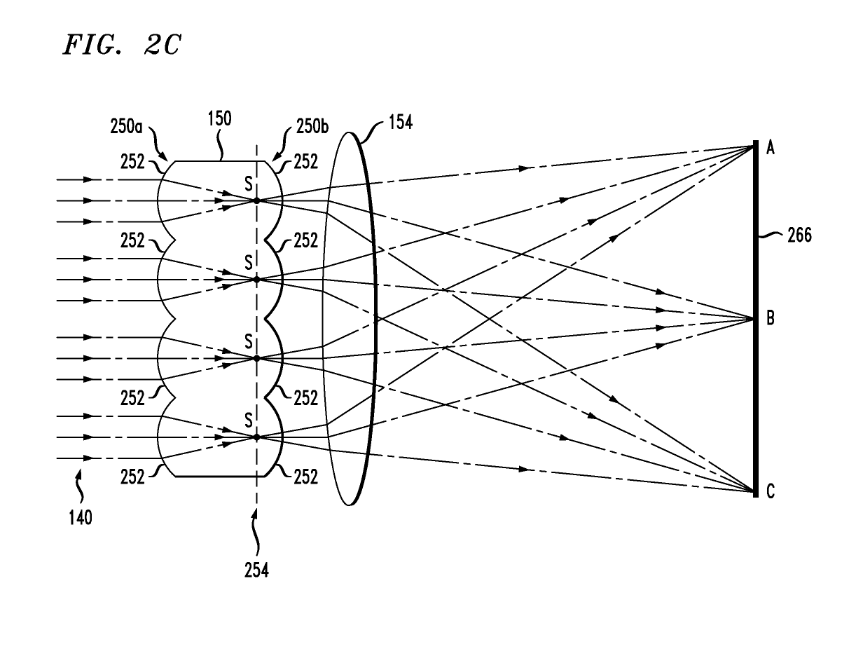

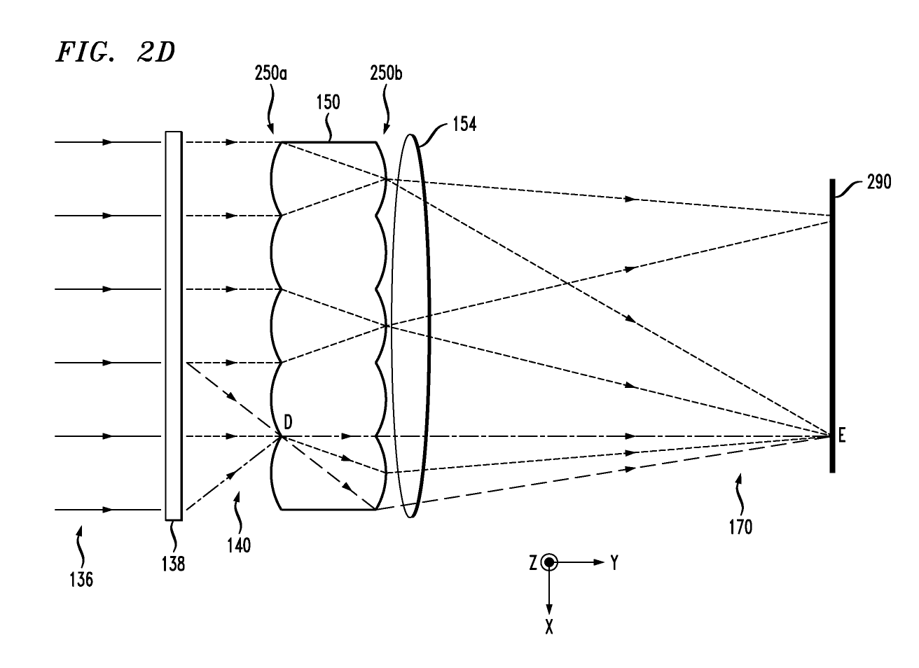

OBS section 130 generally serves to (i) produce substantially uniform illumination of SLM 166 in modulator section 160 and (ii) reduce the appearance of speckle in the image projected onto screen 190. More specifically, OBS section 130 transforms optical beam 128 received from light source 110 into optical beam 158 and applies the latter beam to modulator section 160. The transformation of optical beam 128 into optical beam 158 in OBS section 130 is described in more detail below in reference to FIGS. 2A-D.

SLM 166 is optically coupled in modulator section 160 to PBS 162 as indicated in FIG. 1. PBS 162 is oriented with respect to the polarization of beam 158 so as to redirect substantially all light of that beam, through field lens 164, toward SLM 166. SLM 166 has a plurality of pixels, with each pixel configurable to be in an ON state or in an OFF state. In both states, a pixel reflects the received light back toward PBS 162. In the process of reflection, the polarization of light is rotated by about 90 degrees for the ON state, but not rotated for the OFF state. For example, if the received light is S-polarized, then the reflected light is P-polarized for the ON state, but remains S-polarized for the OFF state. Subsequently, the light reflected by an ON-state pixel is transmitted through PBS 162 toward projection lens 180. However, the light reflected by an OFF-state pixel is reflected by PBS 162 back towards OBS section 130 and, hence, is not directed toward projection lens 180.

In various alternative embodiments, SLM 166 can operate in a transmission mode such that the light transmitted by fly's eye integrator 150 is transmitted sequentially through SLM 166 and PBS 162 toward projection lens 180. In such a transmission mode, a non-beam splitting polarizer can be substituted for the bean-splitting type polarizer illustrated. The term “fly's eye integrator” refers to an arrangement of structures configured to spatially integrate light to improve transmission efficiency and uniformity of the illumination over that provided by simple conventional lenses. For example, a structural arrangement including pairs of lenslets with one lenslet of a pair positioned at about the focal plane of the other lenslet of the pair.

SLM 166 can display a new pattern for each laser pulse. The polarization change induced by SLM 166 causes the light reflected by the SLM (from the pixels that are in the ON state) to be transmitted by PBS 162 towards projection lens 180 and screen 190, without being reflected by the PBS back toward OBS section 130. In effect, projection lens 180 is used to image the reflection pattern displayed by SLM 166 onto screen 190. If the pulse repetition rate is sufficiently high (e.g., greater than the flicker fusion rate), then the images corresponding to the three different colors are fused together in the human eye, thereby creating a perceived color image.

One skilled in the art will understand that light modulation by each pixel can be (i) binary, e.g., as described above (the pixel is either ON or OFF, so that the corresponding spot in the image is either bright or dark), or (ii) on a gray scale, which is achieved by a digital driving scheme at a rate faster than the image refresh rate for SLM 166. An alternative way to implement the gray-scale mode is to drive SLM 166 in an analog manner, wherein a pixel can be fully ON, fully OFF, and anything in between.

In various embodiments, SLM 166 is a liquid-crystal-on-silicon (LCOS) spatial light modulator. A suitable LCOS SLM that can be used as SLM 166 is manufactured by JVC Corporation and is commercially available as part of JVC Projector Model DLA-HD2K. In various alternative embodiments, SLM 166 can be a reflective switching fabric, such as a Micro-Electro-Mechanical Systems (MEMS) switch.

FIGS. 2A-D illustrate various functions and/or operation of the optical elements used in OBS section 130 of projector 100. More specifically, OBS section 130 comprises a pair of crossed cylindrical lenses 134a-b, an optical diffuser 138, a fly's eye (FE) integrator 150, and a condenser lens 154 (see FIG. 1). The focusing surface of cylindrical lenses 134a-b can be cylindrical or aspherical. FIGS. 2A-B schematically show the beam-shaping action of crossed cylindrical lenses 134a-b. FIG. 2C shows a ray-trace analysis that illustrates the operation of FE integrator 150 and condenser lens 154. FIG. 2D schematically shows the effect of optical diffuser 138 on optical beam 170.

FIGS. 2A-B show top and side views, respectively, of crossed cylindrical lenses 134a-b. Lenses 134a-b are termed “crossed” because their cylindrical axes are orthogonal to one another. More specifically, the cylindrical axis of lens 134a is parallel to the Z coordinate axis while the cylindrical axis of lens 134b is parallel to the X coordinate axis. In FIGS. 2A-B, point O represents the virtual origin of diverging light beam 128. One skilled in the art will understand that point O corresponds to the exit apertures of lasers 112/116 (see FIG. 1).

Lens 134a has a shorter focal length than lens 134b because the divergence angle of optical beam 128 in the horizontal (XY) plane is greater than the divergence angle of that beam in the vertical (YZ) plane. Light beam 128 first passes through lens 134a, which collimates that beam in the horizontal plane (see FIG. 2A) but does not affect its divergence in the vertical plane (see FIG. 2B). Collimation here refers to a reduction in the divergence of optical beam 128. A resulting partially collimated light beam 135 then passes through lens 134b, which collimates that beam in the vertical plane, thereby producing a collimated optical beam 136 (see FIG. 2B). In one embodiment, the focal lengths of lenses 134a-b and the distance between these lenses are selected so as to cause optical beam 136 to have about the same height and width and an approximately circular cross-section. The circular cross-section of optical beam 136 helps to (i) maximize the utilization of FE integrator 150 and (ii) increase the illumination-angle diversity at SLM 166. In an alternative embodiment, where a different aspect ratio and/or cross-sectional shape of optical beam 136 are desired, the focal lengths of cylindrical lenses 134a-b are chosen accordingly.

FIG. 2C shows a top view of FE integrator 150 and condenser lens 154 in OBS section 130. Optical diffuser 138 is omitted for clarity. Plane 266 corresponds to the front panel of SLM 166 (see FIG. 1).

FE integrator 150 comprises two two-dimensional arrays 250a-b of spherical lenslets 252. Lenslet arrays 250a and 250b are hereafter referred to as the objective lenslet array and the field lenslet array, respectively. Lenslet arrays 250a-b are arranged in a tandem as indicated in FIG. 2C. In this tandem, lenslets 252 are arranged in pairs of opposing lenslets, with each such pair having a lenslet 252 from objective lenslet array 250a and a corresponding lenslet from field lenslet array 250b. Although FE integrator 150 shown in FIGS. 1 and 2C is implemented as a single optical piece, it can alternatively be implemented using two separate pieces, one piece having objective lenslet array 250a and the other piece having field lenslet array 250b. Lenslets 252 can be formed of various materials, such as a glass fiber that is commonly used in optical communication devices, a glass composite (e.g., quartz or a borosilicate), a plastic (e.g., a polycarbonate or organic polymer suitable for transmitting visible light), or a semiconductor (e.g., a III-V semiconductor). Lenslet 252 can be formed as a graded refractive index structure to reduce the thickness of FE integrator 150. Different lenslets 252 can be formed of different materials or the same material. Accordingly, lenslet arrays 250a and 250b can be formed of different materials, each array including a homogeneous material structure or heterogeneous material structure.

The thickness of FE integrator 150 is selected so that lenslet arrays 250a-b are located in each other's focal planes. As a result, each lenslet 252 of objective lenslet array 250a images the angular distribution of the corresponding portion of an incoming optical beam 140 (see also FIG. 1) on the footprint of its opposing lenslet 252 in field lenslet array 250b. In one embodiment, the focal lengths of lenslets from lenslet arrays 250a and 250b are approximately equal. In various alternative embodiments, one or more of the focal lengths, geometry, and F-number of lenslets from lenslet arrays 250a and 250b are selected to be functionally compatible with the geometry and/or size of SLM 166. In one embodiment, the F-number of lenslets 252 is between about 1.3 and about 4.

In the absence of optical diffuser 138, optical beam 140 is substantially the same as optical beam 136 (see also FIGS. 1 and 2A-B) and is a substantially collimated beam. When objective lenslet array 250a is illuminated with a collimated optical beam, the angular distribution of that beam is very narrow, which produces a plurality of virtual point sources S at a focal plane 254 of the objective lenslet array. Each lenslet 252 of field lenslet array 250b images its opposing lenslet 252 of objective lenslet array 250a at infinity. The effect of condenser lens 154 is to superimpose these images and place them at the front panel of SLM 166 (plane 266 in FIG. 2C), which is placed at the focal plane of the condenser lens. As used herein, the term “superimpose” refers to an overlap of the illumination patches (light spots) produced by different pairs of opposing lenslets 252 on SLM 166. Due to the illumination-patch superposition, each pair of opposing lenslets 252 transmits light that illuminates substantially the entire active area of SLM 166. As a result, each point within the active area of SLM 166 receives light having a range of incident angles, e.g., as indicated in FIG. 2C by the light cones received by points A, B, and C on plane 266.

With continued reference to FIG. 2C, let us suppose now that optical beam 140 is not perfectly collimated, but rather, has some degree of angular divergence. Due to the presence of divergence, virtual point sources S at focal plane 254 become non-point sources whose lateral dimensions correspond to the amount of divergence in optical beam 140. In the absence of field lenslet array 250b, the lateral spread of virtual point sources S can produce two detrimental effects. The first detrimental effect would be that the illumination area on plane 266 corresponding to any particular lenslet 252 would spread laterally beyond the active area of SLM 166, with the extent of this lateral spread depending on the amount of divergence in beam 140. The second detrimental effect would be that the superposition of the illumination areas on plane 266 corresponding to different lenslets 252 would be disturbed so that different lenslets would illuminate different and poorly overlapping areas on that plane. However, the presence of field lenslet array 250b in FE integrator 150 can mitigate both of these two detrimental effects. More specifically, the illumination area on plane 266 corresponding to any particular pair of opposing lenslets 252 remains substantially the same and independent (within certain limits) of the amount of divergence in beam 140. Similarly, the illumination areas on plane 266 corresponding to different pairs of opposing lenslets 252 remain superimposed despite the angular divergence and continue to cover the active area of SLM 166 substantially without spreading out.

FIG. 2D shows a top view of optical diffuser 138, FE integrator 150, and condenser lens 154 in OBS section 130 and demonstrates how the above-described properties of the FE-integrator/condenser-lens combination can be used to mitigate the appearance of speckle in an image formed by projector 100 on screen 190. Plane 290 in FIG. 2D corresponds to screen 190 (FIG. 1). Ray traces corresponding to modulator section 160 are omitted for clarity. One skilled in the art will understand that this omission does not qualitatively alter the angular ray patterns at plane 290.

Optical diffuser 138 diffuses the collimated light of optical beam 136 into relatively small random angles as (exaggeratingly) illustrated in FIG. 2D by the cone of light that converges at point D on the surface of objective lenslet array 250a. One skilled in the art will understand that other points on the surface of objective lenslet array 250a receive similar cones of light produced by optical diffuser 138. The angles are random in the sense of being a substantially random function across the front surface of objective lenslet array 250a. Optical diffuser 138 is able to produce random incident angles across objective lenslet array 250a because the optical diffuser can be made dynamically configurable, e.g., as described below, with a relatively short configuration time.

In one embodiment, optical diffuser 138 is a transmissive liquid crystal diffuser configured to produce a dynamically changing light-scattering pattern. Temporal changes in the light-scattering pattern produce temporal and spatial variations in the pattern of angular divergence introduced by optical diffuser 138 into optical beam 140.

In an alternative embodiment, optical diffuser 138 is a glass-plate diffuser having a fixed light-scattering texture or microstructure. To produce a dynamically changing pattern of angular divergence in optical beam 140, the glass-plate diffuser shakes, vibrates, or moves in an oscillatory manner to move its light-scattering texture/microstructure with respect to FE integrator 150. One skilled in the art will appreciate that various types of periodic or non-periodic motion of optical diffuser 138 can be used. For example, optical diffuser 138 can be configured to move along a planar trajectory that is parallel to the XZ plane (see FIGS. 1 and 2D). The planar trajectory may be shaped so that the trajectory of any selected point of optical diffuser 138 is confined within a rectangle. The planar trajectory may be further shaped to have one or more linear portions, each of which produces a translation of optical diffuser 138 in the corresponding direction. The trajectory may similarly have one or more curved portions, each of which produces a movement of optical diffuser 138 that can be decomposed into a translational movement component and a rotational movement component having its rotation axis substantially parallel to the Y axis. In one configuration, optical diffuser 138 can move along a three-dimensional trajectory. It is preferred that this three-dimensional trajectory has a substantial portion that produces a movement component that is parallel to the XZ plane. The amplitude of movement for the optical diffuser can range from about 10 micron to about 5 mm. In various embodiments, optical diffuser 138 can be configured to vibrate along one or more axial, radial, and/or elliptical directions.

Due to the above-described properties of the FE-integrator/condenser-lens combination in OBS section 130, the angular divergence introduced by optical diffuser 138 into optical beam 140 does not noticeably affect the sharpness of the edges of the illumination patch projected onto the active area of SLM 166 and, also, the sharpness of the image formed on screen 190. However, the dynamic variation in the pattern of divergence in optical beam 140 produced by the motion of a glass-plate diffuser causes the corresponding variations in the angular composition of the optical rays received at each point on screen 190. For example, the ray-trace analysis shown in FIG. 2D demonstrates that the rays emanating from point D on objective lenslet array 250a converge at the same point (i.e., point E) on plane 290, hence the unaffected sharpness. At the same time, point E receives an angular distribution of rays that is related to the angular distribution of rays applied by optical diffuser 138 to point D. One skilled in the art will understand that a similar ray-trace analysis applies to other points on plane 290.

In laser image projectors, speckle reduction is generally based on averaging two or more independent speckle configurations within the spatial and/or temporal resolution of the detector, such as the human eye. For the human eye, the averaging time can be deduced from a physiological parameter called the flicker fusion threshold or flicker fusion rate. More specifically, light that is pulsating at a rate lower than the flicker fusion rate is perceived by humans as flickering. In contrast, light that is pulsating at a rate higher than the flicker fusion rate is perceived as being constant in time. Flicker fusion rates vary from person to person and also depend on the individual's level of fatigue, the brightness of the light source, and the area of the retina that is being used to observe the light source. Nevertheless, very few people perceive flicker at a rate higher than about 75 Hz. Indeed, in cinema and television, frame delivery rates are between 20 and 60 Hz, and 30 Hz, is normally used. For the overwhelming majority of people, these rates are higher than their flicker fusion rate.

Independent speckle configurations may be produced using diversification of phase, propagation angle, polarization, and/or wavelength of the illuminating laser beam. As clear from the description given above in reference to FIG. 2D, optical diffuser 138 used in projector 100 is configurable and produces a temporal modulation in the angular composition of optical rays received by each point on screen 190. This temporal modulation in the angular composition causes a corresponding temporal modulation in the relative phases of light received by each point on screen 190. If optical diffuser 138 is being reconfigured at a sufficiently high rate of speed, e.g., higher than the flicker fusion rate, then the appearance of speckle in the projected image is reduced because the phase modulation reduces (or preferably destroys) the coherence of light at each point on screen 190 and suppresses the interference effects that give rise to speckle. As used herein, the terms “configuration,” “configurable,” and “configuring” are intended to include “reconfiguration,” “reconfigurable,” and “reconfiguring,” respectively.

For optimal operation of projector 100, the degree of angular divergence introduced by optical diffuser 138 does not preferably exceed a certain threshold value. More specifically, as already indicated above, each lenslet 252 of objective lenslet array 250a images the angular distribution of the corresponding portion of optical beam 140 on the footprint of its opposing lenslet 252 in field lenslet array 250b. This means that each pair of opposing lenslets 252 in FE integrator 150 has a certain degree of directional acceptance. The extent of this directional acceptance depends on the radius of curvature (or focal length) and lateral dimensions of individual lenslets 252. Only light that falls on a lenslet 252 of objective lenslet array 250a within the angular acceptance of the opposing lenslet 252 in field lenslet array 250b is properly relayed to SLM 166 and then to screen 190. Light beyond this directional acceptance produces crosstalk between neighboring pairs of opposing lenslets 252, which manifests itself in form of detrimental ghost illumination patches within the active area of SLM 166.

In various embodiments, different optical elements of OBS section 130 work together in a synergistic manner to enable projector 100 to increase optical throughput between laser source 110 and screen 190 and/or reduce speckle noise in the projected image. For example, the above-described properties of the combination of FE integrator 150 and optical diffuser 138 enable projector 100 to have high optical throughput between laser source 110 and screen 190, high illumination homogeneity across SLM 166 and the screen, and high temporal/spatial stability of the illumination patch despite the angular divergence and temporal variability introduced by configurations of the optical diffuser. At the same time, FE integrator 150 and optical diffuser 138 are able to provide for effective diversification of propagation angle and phase at screen 190, which reduces the speckle noise in the projected image in a very efficient manner.

In contrast, typical prior-art solutions disadvantageously suffer from optical-efficiency losses and/or temporal/spatial instabilities because the use of an optical diffuser makes the light passing therethrough relatively difficult to collect due to the fact that this light is spatially divergent and temporally shifting. In general, the inherent contradiction between (i) the desired homogeneity and stability of the illumination patch for the production eye-pleasing images and (ii) the required high temporal and spatial variability within the illumination patch for speckle-reduction purposes forces prior-art designs to make concessions and/or compromises in either the optical throughput or the attainable level of speckle noise, or both. These problems inherent to prior-art designs can be overcome in projector 100 by the use, in the above-described manner, of FE integrator 150 and optical diffuser 138. This use can advantageously make the above-mentioned concessions/compromises unnecessary and avoidable.

The use of crossed cylindrical lenses 134a-b in OBS section 130 further helps to maximize the above-described advantages of projector 100 over the prior art. More specifically, crossed cylindrical lenses 134a-b enable OBS section 130 to tailor the cross-section of optical beam 136 applied to optical diffuser 138 and thereafter to FE integrator 150 so that (i) the cross-section substantially matches the lateral size/geometry of the FE integrator and (ii) the angular spread in the light received at each particular point on screen 190 is effectively maximized. The former characteristic helps to achieve a high optical throughput despite the anisotropic properties of the laser beams (i.e., elliptical emission cones) produced by lasers 112 in laser source 110. The latter characteristic helps to increase the diversification of angle at screen 190 to a maximum possible degree for the given lateral size of FE integrator 150 (see, e.g., FIG. 2C), which maximization serves to enhance the speckle-reduction capacity of projector 100.

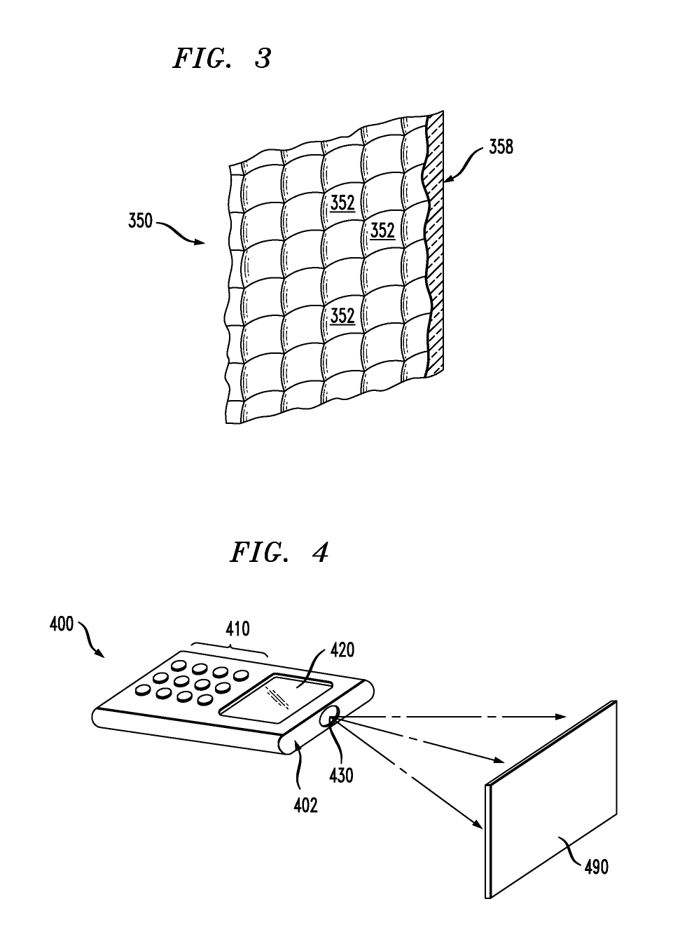

FIG. 3 shows a lenslet array 350 that can be used as lenslet array 250 according to one embodiment of the invention. Lenslet array 350 has a plurality of lenslets 352, each having a square or rectangular footprint matching the shape of the active area of SLM 166 (e.g., rectangular shapes with a 4:3 or 16:9 aspect ratio). Lenslets 352 have planar back surfaces and are arranged side by side on a common base plane 358. The shape of the front surface of an individual lenslet 352 has a curvature. Exemplary shapes that can be used to implement the front surface of lenslet 352 are spherical, parabolic, conic aspheric, even aspheric, and cylindrical. In general, lenslet array 350 can include most any size or shape, including circular and elliptical shapes. In various embodiments, lenslet array 350 is shaped to capture most (e.g., more than 80%) of the incoming beam of light. The individual lenslets 352 forming array 350 can also include most any size or geometry, including circular and elliptical, according to the desired shape of the active area of SLM 166.

Lenslet array 350 can have a dimension ranging, e.g., from about 1 mm to about 20 mm on a side. Lenslet 352 can have an in-plane dimension ranging, e.g., from about 50 μm to about 1 mm. F-numbers for lenslet 352 can range, e.g., from about 0.8 to about 10. These parameters are chosen so that the illumination light patch on SLM 166 can match, to a desired extent, the size and/or geometry of the active area of the SLM.

An exemplary lenslet 352 is square or rectangular and the lenslet array is a two dimensional array of lenslets 352, as illustrated in FIG. 3. Lenslet 352 can also be an elongated cylindrical lens, wherein lenslet array 350 is formed to have rows of pairs of elongated cylindrical lenslets. An FE integrator constructed from pairs of elongated cylindrical lenslets can perform as an FE integrator in one of the two transverse spatial directions. Two FE integrators having rows of elongated cylindrical lenslets arranged with their respective cylindrical axis crossed can be used instead of a two dimensional FE integrator described above for square or rectangular geometry.

FIG. 4 shows a three-dimensional perspective view of a hand-held electronic device 400 according to one embodiment of the invention. In various embodiments, device 400 can be a cell phone, PDA, media player, etc. Device 400 has a set of control keys 410 and a relatively small regular display screen 420. A narrow terminal side (edge) of device 400 has an opening 430 that serves as an optical output port for a projector built into the device. In various embodiments, device 400 can incorporate various embodiments of projector 100. In FIG. 4, the projector of device 400 is illustratively shown as projecting a relatively large image onto a piece 490 of white paper.

While this invention has been described with reference to illustrative embodiments, this description is not intended to be construed in a limiting sense. Although speckle reduction in projector 100 has been described in reference to configurable optical diffuser 138, other speckle reduction methods, e.g., those employing polarization and/or wavelength diversities, can additionally be used in that projector. For example, an optional polarization rotator 168 can be configurable and placed (i) between PBS 162 and projection lens 180 or (ii) within the projection lens, or (iii) after the projection lens to impart temporal variations on the state of polarization of beam 170 (see FIG. 1). Provided that screen 190 has some depolarizing characteristics, the varying state of polarization produced by polarization rotator 168 helps to increase the number of independent speckle configurations at the screen, thereby reducing the appearance of speckle thereon. Although FE integrator 150 has been described as a tandem lenslet array having spherical lenslets, in an alternative embodiment, FE integrator 150 can comprise two serially arranged tandem lenslet arrays, each having cylindrical lenslets, with the cylindrical lenslets of the first tandem array being in a crossed orientation with respect to the cylindrical lenslets of the second tandem array. Additional optical elements can be used in projector 100 as known in the art. For example, a quarter-wave plate can be incorporated for polarization compensation and/or improving the image contrast. Various modifications of the described embodiments, as well as other embodiments of the invention, which are apparent to persons skilled in the art to which the invention pertains are deemed to lie within the principle and scope of the invention as expressed in the following claims.

As used herein, the phrase “superimposed in a manner that is substantially independent of temporal variations” means that the illumination patches (light spots) produced by different pairs of opposing lenslets 252 of FE integrator 150 on the active area of SLM 166 remain overlapped with an overlap area that is, e.g., greater than about 90% of the area of an individual illumination patch despite the presence of temporal variations in the pattern of angular divergence produced by optical diffuser 138.

Embodiments of the invention(s) described above may be embodied in other specific apparatus and/or methods. For example, an image-projection structure disclosed herein can be used for near-eye display applications if projection lens 180 is modified to provide a virtual image of SLM 166 to enable image viewing by looking directly toward projection lens 180 rather than the screen. For such applications, the use of optical diffuser 138 might be optional because the speckle noise may not be strong enough to be sufficiently detrimental to the viewing experience, although inclusion of the diffuser can still assist in enhancing the uniformity of illumination. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

Unless explicitly stated otherwise, each numerical value and range herein should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments as some embodiments can be combined with other embodiments to form new embodiments. The same applies to the term “implementation.”

The use of terms such as height, length, width, top, bottom, is strictly to facilitate the description of the invention and is not intended to limit the invention to a specific orientation. For example, height does not imply only a vertical rise limitation, but is used to identify one of the three dimensions of a three dimensional structure as shown in the figures. Such “height” would be vertical where the electrodes are horizontal but would be horizontal where the electrodes are vertical, and so on. Similarly, while all figures show the different layers as horizontal layers such orientation is for descriptive purpose only and not to be construed as a limitation.

The terms “couple,” “coupling,” “coupled,” “connect,” “connecting,” or “connected” refer to any manner in which energy is allowed to be transferred between two or more elements, and includes the indirect transfer of energy such that the interposition of one or more additional elements is contemplated, although not required. Conversely, the terms “directly coupled,” “directly connected,” etc., imply the absence of such additional elements.

What is claimed is:

1. An optical device for projecting an image, the optical device comprising:
a configurable optical diffuser adapted to produce a diffuse optical beam having a temporally varying pattern of angular divergence;
a fly's eye (FE) integrator adapted to shape the diffuse optical beam; and
a spatial light modulator (SLM) adapted to spatially modulate a shaped optical beam produced by the FE integrator to project the image.

2. The invention of claim 1, wherein:
the FE integrator comprises a plurality of lenslet pairs arranged side by side with each other; and
the plurality of lenslet pairs include different lenslet pairs that produce, on the SLM, a superposition of corresponding illuminated regions that is substantially independent of temporal variations introduced by the configurable optical diffuser.

3. The invention of claim 2, wherein the focal lengths of the lenslets in a lenslet pair are substantially matched.

4. The invention of claim 1, wherein the FE integrator comprises one or more lenslet pairs in which opposing faces are parts of a single optical piece.

5. The invention of claim 1, further comprising a pair of crossed cylindrical lenses to produce an optical beam applied to the configurable optical diffuser.

6. The invention of claim 5, wherein the crossed cylindrical lenses of said pair have different focal lengths.

7. The invention of claim 1, wherein the configurable optical diffuser comprises a transmissive liquid-crystal structure adapted to display a dynamically changing light-scattering pattern.

8. The invention of claim 1, wherein the configurable optical diffuser is a transmissive plate adapted for movement with respect to the FE integrator.

9. The invention of claim 1, further comprising a polarization beam splitter (PBS) to couple light from the FE integrator to the spatial light modulator.

10. The invention of claim 1, further comprising an illumination source including one or more lasers adapted to generate light applied to the configurable optical diffuser.

11. The invention of claim 10, wherein the one or more lasers include a first laser adapted to generate light having different angular divergence along at least two different axes orthogonal to the emission axis of the first laser.

12. The invention of claim 1, wherein the configurable optical diffuser is to receive light from a time-division multiplexed source.

13. The invention of claim 1, further comprising a color combiner adapted to direct multicolored light toward the configurable optical diffuser.

14. An optical device for projecting an image, the optical device comprising:
a pair of crossed cylindrical lenses to provide collimated coherent light;
a moveable diffuser to receive the collimated coherent light to produce a diffuse optical beam having a temporally varying pattern of angular divergence; and
a plurality of lenslet pairs arranged side by side with each other and adapted to shape the diffuse optical beam.

15. The invention of claim 14, further comprising a spatial light modulator adapted to receive at least a portion of a shaped optical beam produced the by plurality of lenslet pairs.

16. The invention of claim 15, further comprising a polarization beam splitter adapted to direct at least a portion of the shaped optical beam toward the spatial light modulator.

17. The invention of claim 14, further comprising a light source including at least one coherent light emitter to be optically coupled to the pair of crossed cylindrical lenses.

18. The inventions of claim 14, wherein the plurality of lenslet pairs is configured as a fly's eye integrator structure.

19. The invention of claim 14, further comprising a light combiner adapted to direct light to the pair of crossed cylindrical lenses.

20. The invention of claim 14, wherein the plurality of lenslet pairs include at least one pair in which both lenslets have a cylindrical shape.
